(19) United States
(12) Patent Application Publication
(10) Pub. No.: US 2019/0129345 A1
(43) Pub. Date: May 2, 2019

(54) IMAGE FORMING APPARATUS AND CONVEYANCE CONTROL METHOD

(71) Applicant: Konica Minolta, Inc., Tokyo (JP)

(72) Inventors: Takahiro OKUBO, Kanagawa (JP); Yasuo SHIOKAWA, Tokyo (JP); Yoshiteru KAWAKAMI, Tokyo (JP)

(21) Appl. No.: 16/170,580

(22) Filed: Oct. 25, 2018

(30) Foreign Application Priority Data
Oct. 30, 2017 (JP) 2017-209223

(51) Int. Cl. G03G 15/00; G03G 15/16

(52) U.S. Cl. CPC G03G 15/6561; G03G 15/1605

(57) ABSTRACT

An image forming apparatus includes: a transferrer that transfers an image onto a sheet; a registration roller provided upstream of the transferrer in a sheet conveyance direction; and a hardware processor that controls an operation of the registration roller. The hardware processor executes a registration-less operation of not bringing a front end of the sheet in the conveyance direction into contact with the registration roller, and subsequently controls displacement of the registration roller so that a position of an image to be transferred onto the sheet by the transferrer can become correct according to sheet shape information representing a shape of the sheet.

### CROSS REFERENCE TO RELATED APPLICATIONS

The present application claims priority under 35 U.S.C. § 119 to Japanese Patent Application No. 2017-209223 filed on Oct. 30, 2017, the disclosure of which is incorporated herein by reference.

### BACKGROUND

### Technological Field

The present invention relates to an image forming apparatus and a conveyance control method.

### Description of Related Art

In general, an image forming apparatus (such as a printer, a copier, and a facsimile machine) using an electrophotographic processing technique applies (exposes) laser light on the basis of image data to a charged photoconductor drum (image bearing member) to form an electrostatic latent image. In the image forming apparatus, a developing unit supplies toner to the photoconductor drum provided with the electrostatic latent image to visualize the electrostatic latent image to form a toner image. The image forming apparatus further primarily or secondarily transfers the toner image to a sheet and heats and pressurizes the sheet by a fixing nip of a fixing unit to fix the toner image on the sheet. Also, in the image forming apparatus, registration rollers are provided upstream of a transfer section that transfers an image onto a sheet. The registration rollers have a function of rotating so as to adjust the conveyance speed of a sheet, for aligning the front end of the sheet in the conveyance direction with the front end of an image, to feed the sheet into a transfer section.

The conventional registration rollers have a function of allowing a sheet being conveyed to come into contact with the rollers to thereby correct the obliqueness at the front end of the sheet in the conveyance direction, i.e., skew, (hereinafter referred to as skew correction). Furthermore, there are other registration rollers having a function of performing this skew correction and subsequently displacing themselves along the width direction of the sheet to thereby correct the positional deviation of the sheet in the width direction (hereinafter referred to as positional deviation correction) (e.g., see Japanese Patent Application Laid-Open No. 2014-133634).

In the image forming apparatus, typically, a planar, rectangular sheet (a regularly used sheet etc., such as A4) is most frequently used as a transfer sheet for printing (recording material). Meanwhile, for example, materials having various shapes, such as an envelope, an ultrathin or ultrathick sheet material, a roughly cut sheet having non-right angle corners, etc. are sometimes used. Furthermore, there is a high latent demand for printing images on various planar-shaped sheets having shapes other than rectangles.

On the other hand, for securing the accuracy of the position of an image to be transferred (i.e., for securing an image), the operation of the conventional registration roller that performs the skew correction and the positional deviation correction described above requires that the side at the front end of a sheet in the conveyance direction is a straight line, and angles between the straight line and sides at the side edges are the right angle. Specifically, in a case of using a sheet with sides at the front end in the conveyance direction not forming the right angle, the state of sheet obliqueness (skew) sometimes becomes worse (so called inverted correction) during the obliqueness correction described above. In such a case, there is a possibility that even with the positional deviation correction, the obliqueness of a sheet cannot be completely corrected and the sheet reaches the transfer section. The accuracy of the position of an image to be transferred by the transfer section cannot be secured (i.e., incapable of image securing).

### SUMMARY

An object of the present invention is to provide an image forming apparatus and a conveyance control method that can achieve improvement in the positional accuracy of a transferred image for sheets having various shapes.

In order to realize at least one of the above objects, an image forming apparatus reflecting an aspect of the present invention includes:

a transferrer that transfers an image onto a sheet;

a registration roller provided upstream of the transferrer in a sheet conveyance direction; and

a hardware processor that controls an operation of the registration roller;

in which the hardware processor executes a registration-less operation of not bringing a front end of the sheet in the conveyance direction into contact with the registration roller, and subsequently controls displacement of the registration roller so that a position of an image to be transferred onto the sheet by the transferrer can be corrected according to sheet shape information representing a shape of the sheet

In order to realize at least one of the above objects, a conveyance control method of an image forming apparatus reflecting an aspect of the present invention includes a transferrer that transfers an image onto a sheet, and a registration roller provided upstream of the transferrer in a sheet conveyance direction,

the method executing a registration-less operation of not bringing a front end of the sheet in the conveyance direction into contact with the registration roller, and subsequently displacing the registration roller so that a position of an image to be transferred onto the sheet by the transferrer can be correct according to sheet shape information representing a shape of the sheet.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a diagram schematically illustrating an overall configuration of an image forming apparatus according to this embodiment;

FIG. 2 is a diagram illustrating main parts of a control system of the image forming apparatus according to this embodiment;

FIG. 3 is a plan view illustrating an operation of a conventional registration roller pair, and is a diagram illustrating a state where the front end of a sheet in a conveyance direction is in contact with the registration roller pair;

FIG. 4 is a plan view illustrating a second operation (registration-less operation) of a registration roller pair according to this embodiment;

FIG. 5 is a plan view illustrating a configuration provided with a sensor that senses the front end of a conveyed sheet;

FIG. 6 is a plan view illustrating a configuration provided with two sensors that sense the front end of the conveyed sheet;

FIG. 7A and FIG. 7B are diagrams illustrating a case where first and second operations of the registration roller pair are selectable, FIG. 7A illustrates an example of the external shape of a sheet that can be supported by the first operation, and FIG. 7B illustrates an example of the external shape of a sheet that is difficult to be supported by the first operation; and

FIG. 8 is a flowchart illustrating an example of operation control of the registration roller pair according to this embodiment.

### DETAILED DESCRIPTION OF EMBODIMENTS

Hereinafter, one or more embodiments of the present invention will be described with reference to the drawings. However, the scope of the invention is not limited to the disclosed embodiments.

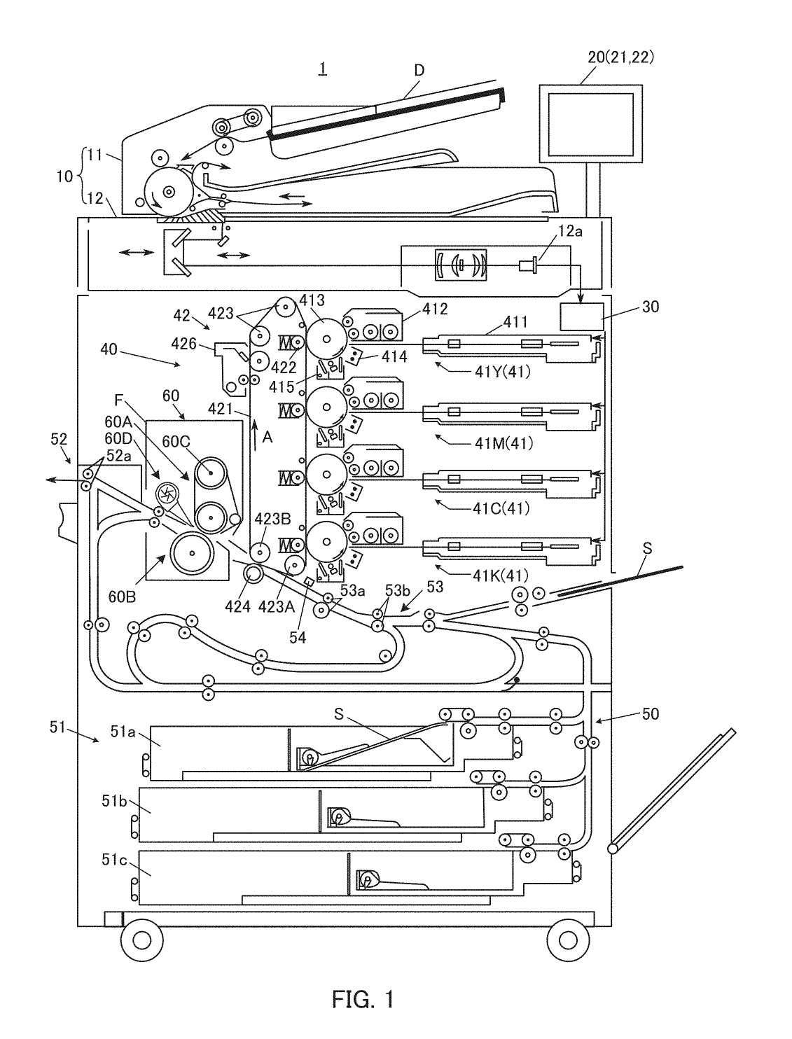

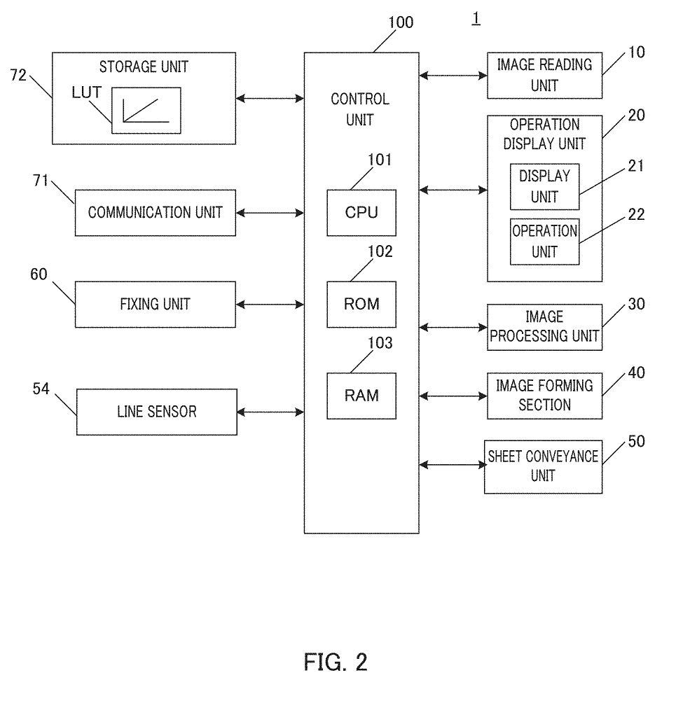

Referring to the accompanying drawings, this embodiment will be described in detail. FIG. 1 is a diagram schematically illustrating an overall configuration of image forming apparatus 1 according to this embodiment. FIG. 2 is a diagram illustrating main parts of a control system of image forming apparatus 1 according to this embodiment.

Image forming apparatus 1 of this embodiment uses, as sheet S, not only regularly used sheets (standard sheets), such as A4-sized and A3-sized sheets, which are typically used, but also various special sheets. Images are formed on such sheets S.

In this embodiment, special sheets can include, for example, various modes, such as envelopes, long sheets having a longer length in the conveyance direction than the standard sheet has, ultrathin or ultrathick sheets, label sheets, roughly cut sheets having non-right angle corners, trapezoid and parallelogram sheets, triangles or polygons having five or more corners, sheets having curved sides, sheets made of materials other than paper (e.g., resin).

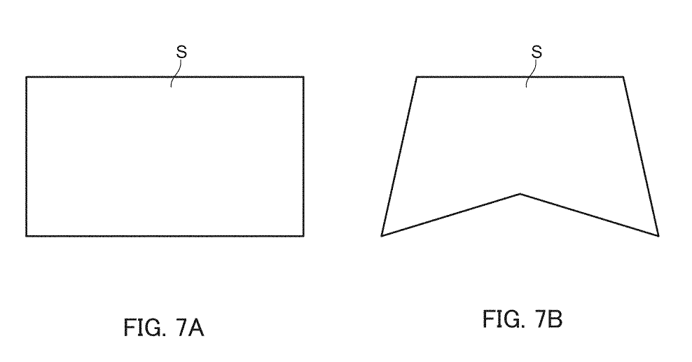

Hereinafter, sheet S or simply “sheet” can include both the regularly used sheets (standard sheets) and the special sheets. As an example of use of a special sheet, a case where an image is formed on sheet S having a special shape as shown in FIG. 7B (a pentangular planar shape having two acute angles and three obtuse angles) is mainly described.

Image forming apparatus 1 is a color image forming apparatus of an intermediate transfer system using an electrophotographic process technique. More specifically, image forming apparatus 1 primarily transfers toner images of colors Y (yellow), M (magenta), C (cyan), and K (black) formed on photoconductor drums 413 to intermediate transfer belt 421 and places the toner images of four colors on top of each other on intermediate transfer belt 421. Image forming apparatus 1 then secondarily transfers the toner images to the sheet to form a toner image.

A tandem system is adopted in image forming apparatus 1, in which photoconductor drums 413 corresponding to four colors of YMCK are disposed in series in a traveling direction of intermediate transfer belt 421, and the toner images of the colors are sequentially transferred to intermediate transfer belt 421 in one procedure.

As shown in FIG. 2, image forming apparatus 1 includes image reading unit 10, operation display unit 20, image processing unit 30, image forming section 40, sheet conveyance unit 50, fixing unit 60, control unit 100, and the like.

Control unit 100 includes CPU (Central Processing Unit) 101, ROM (Read Only Memory) 102, RAM (Random Access Memory) 103, and the like. CPU 101 reads a program according to details of processing from ROM 102 and loads the program in RAM 103. CPU 101 comprehensively controls the operation of blocks of image forming apparatus 1 in cooperation with the loaded program. In this case, CPU 101 references various types of data stored in storage unit 72. Storage unit 72 includes, for example, a non-volatile semiconductor memory (so-called flash memory) or a hard disk drive.

Control unit 100 transmits and receives various types of data to and from an external apparatus (for example, personal computer (PC)) connected to a communication network, such as LAN (Local Area Network) and WAN (Wide Area Network), through communication unit 71. For example, control unit 100 receives image data transmitted from the external apparatus and forms a toner image on the sheet based on the image data (input image data). Communication unit 71 includes, for example, a communication control card such as a LAN card.

Image reading unit 10 includes automatic original sheet feeding apparatus 11 called an ADF (Auto Document Feeder), original image scanning apparatus 12 (scanner), and the like.

Automatic original sheet feeding apparatus 11 conveys original D mounted on an original tray based on a conveyance mechanism and sends out original D to original image scanning apparatus 12. Automatic original sheet feeding apparatus 11 can continuously read, without pausing, images (including double-sided) of many pieces of original D mounted on the original tray.

Original image scanning apparatus 12 optically scans the original conveyed onto a contact glass from automatic original sheet feeding apparatus 11 or the original mounted on the contact glass and forms an image on a light-receiving surface of CCD (Charge Coupled Device) sensor 12a based on reflected light from the original to thereby read the original image. Image reading unit 10 generates input image data based on the reading result of original image scanning apparatus 12. Image processing unit 30 applies predetermined image processing to the input image data.

Operation display unit 20 includes, for example, a liquid crystal display (LCD) with a touch panel and functions as display unit 21 and operation unit 22. Display unit 21 displays various operation screens, states of images, operation conditions of functions, and the like according to display control signals input from control unit 100. Operation unit 22 includes various operation keys, such as numeric keys and a start key. Operation unit 22 receives various input operations by the user and outputs operation signals to control unit 100.

Image processing unit 30 includes a circuit or the like that applies digital image processing to the input image data according to initial setting or user setting. For example, image processing unit 30 performs tone correction based on tone correction data (tone correction table LUT) in storage unit 72 under the control of control unit 100. Other than the tone correction, image processing unit 30 also applies various correction processes, such as color correction and shading correction, compression processing, and the like to the input image data. Image forming section 40 is controlled based on the processed image data.

Image forming section 40 includes: image forming units 41Y, 41M, 41C, and 41K that form images using colored toners of Y component, M component, C component, and K component based on the input image data; intermediate transfer unit 42; and the like.

Image forming units 41Y, 41M, 41C, and 41K for Y component, M component, C component, and K component have similar configurations. For the convenience of the illustration and the description, common constituent elements are indicated by the same reference signs, and Y, M, C and K are attached to the reference signs to distinguish the constituent elements. In FIG. 1, the reference signs are provided only to the constituent elements of image forming unit 41Y for Y component, and the reference signs are not illustrated for the constituent elements of the other image forming units 41M, 41C, and 41K.

Image forming unit 41 includes exposing device 411, developing device 412, photoconductor drum 413, charging device 414, drum cleaning apparatus 415, and the like.

Photoconductor drum 413 is, for example, a negative charge type organic photo-conductor (OPC) including an under coat layer (UCL), a charge generation layer (CGL), and a charge transport layer (CTL) sequentially laminated on a peripheral surface of an aluminum conductive cylindrical body (aluminum tube). The charge generation layer is made of an organic semiconductor in which a charge generation material (for example, phthalocyanine pigment) is dispersed on a resin binder (for example, polycarbonate), and the charge generation layer generates a pair of positive charge and negative charge based on exposure by exposing device 411. The charge transport layer is a layer in which a hole transport material (electron-donating nitrogen-containing compound) is dispersed on a resin binder (for example, polycarbonate resin), and the charge transport layer transports the positive charge generated by the charge generation layer to the surface of the charge transport layer.

Control unit 100 rotates photoconductor drum 413 at a constant circumferential speed (linear speed) by controlling a drive current supplied to a drive motor (not shown) that rotates photoconductor drum 413.

Charging device 414 uniformly applies a negative charge to the photoconductive surface of photoconductor drum 413. Exposing device 411 includes, for example, a semiconductor laser and applies laser light to photoconductor drum 413 according to the image of each color component. As a result, an electrostatic latent image of each color component is formed on the surface of photoconductor drum 413 due to the potential difference between the surface and the surroundings.

Developing device 412 is, for example, a two-component development type developing device, and developing device 412 attaches the toner of each color component to the surface of photoconductor drum 413 to visualize the electrostatic latent image to form the toner image.

Drum cleaning apparatus 415 includes a cleaning blade or the like brought into sliding contact with the surface of photoconductor drum 413. A cleaning blade in drum cleaning apparatus 415 removes the remaining transfer toner left on the surface of photoconductor drum 413 after the primary transfer.

Intermediate transfer unit 42 includes intermediate transfer belt 421, primary transfer roller 422, a plurality of support rollers 423, secondary transfer roller 424, belt cleaning apparatus 426, and the like.

Intermediate transfer belt 421 includes an endless belt and is stretched by a plurality of support rollers 423 in a loop shape. At least one of support rollers 423 is a driving roller, and other support rollers 423 are driven rollers. For example, it is preferable that roller 423A disposed on the downstream of primary transfer roller 422 for K component in the belt traveling direction be a driving roller. As a result, the traveling speed of the belt in the primary transfer section can be easily maintained at a constant speed. Driving roller 423A rotates, and intermediate transfer belt 421 travels at a constant speed in an arrow A direction.

Primary transfer roller 422 faces photoconductor drum 413 of each color component and is disposed on an inner peripheral side of intermediate transfer belt 421. Primary transfer roller 422 is pressed against photoconductor drum 413 across intermediate transfer belt 421, and a primary transfer nip for transferring the toner image from photoconductor drum 413 to intermediate transfer belt 421 is formed.

Secondary transfer roller 424 faces backup roller 423B disposed on the downstream of driving roller 423A in the belt traveling direction, and secondary transfer roller 424 is disposed on an outer peripheral side of intermediate transfer belt 421. Secondary transfer roller 424 is pressed against backup roller 423B across intermediate transfer belt 421, and a secondary transfer nip for transferring the toner image from intermediate transfer belt 421 to sheet S is formed.

The secondary transfer nip formed by intermediate transfer belt 421, backup roller 423B, and secondary transfer roller 424 corresponds to a “transfer section” of the present invention.

When intermediate transfer belt 421 passes through the primary transfer nip, the toner images on photoconductor drums 413 are primarily transferred to intermediate transfer belt 421 and sequentially placed on top of each other. Specifically, a primary transfer bias is applied to primary transfer roller 422 to provide a charge with a polarity opposite the toner to the side of intermediate transfer belt 421 coming into contact with primary transfer roller 422, and the toner images are electrostatically transferred to intermediate transfer belt 421.

Subsequently, when the sheet S passes through the secondary transfer nip, the toner images on intermediate transfer belt 421 are secondarily transferred to the sheet S. Specifically, a secondary transfer bias is applied to secondary transfer roller 424 to provide a charge with a polarity opposite the toner to the side of the sheet S coming into contact with secondary transfer roller 424, and the toner images are electrostatically transferred to the sheet S. The sheet S provided with the toner images is conveyed toward fixing unit 60.

Belt cleaning apparatus 426 includes a belt cleaning blade or the like in sliding contact with the surface of intermediate transfer belt 421 and removes the remaining transfer toner left on the surface of intermediate transfer belt 421 after the secondary transfer.

Fixing unit 60 includes: upper fixing unit 60A including a fixing surface member disposed on the fixing surface side of sheet S; lower fixing unit 60B including a back surface support member disposed on the opposite side of the fixing surface of sheet S; heat source 60C; and the like. The back surface support member is pressed against the fixing surface member to form a fixing nip for sandwiching and conveying sheet S.

Fixing unit 60 fixes the toner image to sheet S by heating and pressurizing, in the fixing nip, conveyed sheet S on which the toner images have been secondarily transferred. Fixing unit 60 is disposed as a unit in fixing device F. Air separation unit 60D that separates sheet S from the fixing surface member by blowing air is disposed in fixing device F.

Sheet conveyance unit 50 includes sheet feeding unit 51, sheet ejection unit 52, conveyance path unit 53, and the like. Three sheet feed tray units M a to 51c of sheet feeding unit 51 hold sheets S (standard sheets, special sheets) according to preset types identified based on the basis weight (stiffness), the size, and the like. Conveyance path unit 53 includes a plurality of conveyance rollers, such as registration roller pair 53a and loop rollers 53b, a double-sided conveyance path for forming images on both sides of sheet S, an external sheet feed conveyance path for feeding sheet S from the outside (the right in FIG. 1) of the apparatus, and the like. Registration roller pair 53a corresponds to a “registration roller” of the present invention.

Under the control of control unit 100, registration roller pair 53a serves as a component that performs skew correction of sheet S, and serves as a component that performs positional deviation correction of sheet S. Registration roller pair 53a has a function of adjusting the conveyance speed of the sheet by rotating so as to align the position of the toner image in the conveyance direction, under the control of control unit 100, the toner image being to be secondarily transferred onto the sheet.

Here, the skew correction is correction of the obliqueness at the front end of sheet S in the conveyance direction, i.e., skew, by bringing sheet S being conveyed into contact with registration roller pair 53a. In this embodiment, during skew correction of sheet S, a control signal is output from control unit 100 to a drive source (motor etc.) of registration roller pair 53a, thereby controlling the rotation of registration roller pair 53a. Details of the content of control of skew correction of sheet S will be described later.

Meanwhile, the positional deviation correction is correction of the position of sheet S in the width direction by displacement of registration roller pair 53a. In other words, after sheet S is sandwiched at a nip of registration roller pair 53a (hereinafter also referred to as a registration nip), control for displacement operation (registration displacement) to move registration roller pair 53a in the width direction and, in turn, to move sheet S is performed, and the position of sheet S in the width direction is thereby corrected. In this embodiment, as the drive source for displacing registration roller pair 53a, a motor (stepping motor etc.) other than the motor for rotating registration roller pair 53a is used. Details of the content of control of the registration displacement will be described later.

Loop rollers 53b are a pair of rollers disposed upstream of registration roller pair 53a in the conveyance direction. Loop rollers 53b rotate under the control of control unit 100 in such a way that sheet S is looped in the space between registration roller pair 53a and loop rollers 53b to correct obliqueness of sheet S in cooperation with registration roller pair 53a.

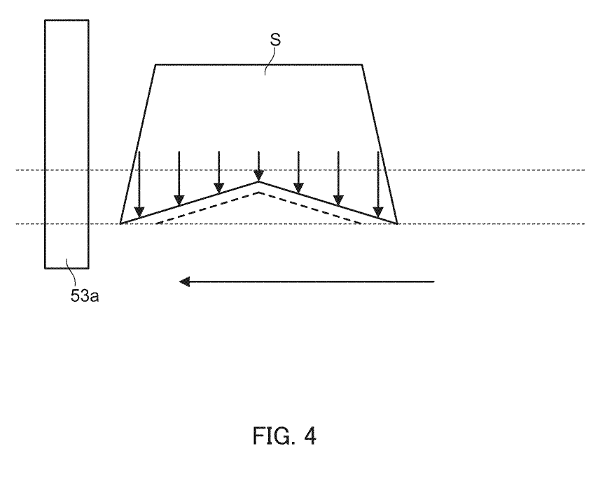

Line sensor 54 is disposed on the downstream of registration roller pair 53a and the upstream of the secondary transfer nip in the sheet conveyance direction. Line sensor 54 is a sensor that is formed of linearly arranged photoelectric conversion elements and serves as a component that detects a one-side edge of sheet S in the width direction thereof (hereinafter referred to as side edge) to sense an offset of sheet S (deviation from the reference or target position (see the broken line in FIG. 4)).

Sheets S housed in sheet feed tray units 51a to 51c are sent out piece by piece from the top and are conveyed by conveyance path unit 53 to image forming section 40. Alternatively, sheet S is conveyed from an external sheet feed tray or a sheet feeding apparatus connected to image forming apparatus 1 (neither is shown) through the external sheet feed conveyance path described above to image forming section 40. At this time, the front end side of fed sheet S in the conveyance direction is brought into contact with registration roller pair 53a, and this front end side is disposed in parallel to the axes of registration roller pair 53a, thereby correcting the obliqueness of sheet S (skew correction) and adjusting the conveyance timing of sheet S.

In image forming section 40, the toner images of intermediate transfer belt 421 are secondarily transferred altogether to one of the surfaces of sheet S, and a fixing process is applied by fixing unit 60. Sheet ejection unit 52 including sheet ejection roller 52a ejects sheet S provided with the images to the outside of the apparatus. Note that during double-sided printing, sheet S after the image formation on a first side is switch-back-conveyed through the double-sided conveyance path, and the front and rear are inverted accordingly. After the front and back are inverted, the toner images are secondarily transferred and fixed to a second side, and sheet ejection unit 52 ejects sheet S to the outside of the apparatus.

In the image forming apparatus, typically, a planar, rectangular sheet (a regularly used sheet etc., such as A4) is most frequently used as a transfer sheet for printing (recording material). Meanwhile, for example, materials having various shapes, such as an envelope, an ultrathin or ultrathick sheet material, a roughly cut sheet having non-right angle corners, etc. are sometimes used. Furthermore, there is a high latent demand for printing images on various planar-shaped special sheets having shapes other than rectangles.

However, for securing the accuracy of the position of the toner image to be printed (for securing an image), the operation of conventional registration roller pair 53a that performs the skew correction and the positional deviation correction described above requires that the side at the front end of the sheet in the conveyance direction is a straight line, and angles between the straight line and sides at the side edges are the right angle.

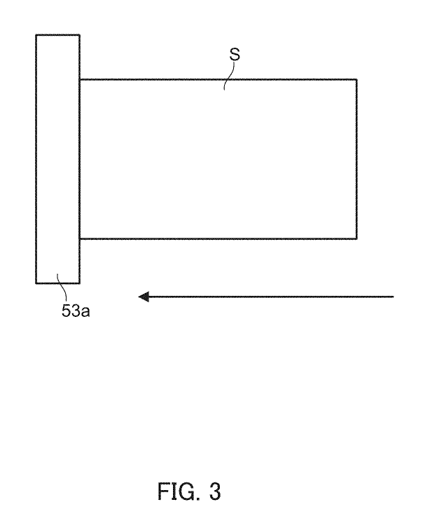

The problem described above will be specifically described with reference to FIG. 3 and the like. Here, FIG. 3 illustrates a state where the front end of rectangular sheet S in the conveyance direction is in contact with registration roller pair 53a. The conveyance direction of sheet S is indicated by an arrow. For simplicity, in FIG. 3, loop rollers 53b are not shown. This is also applicable to FIG. 4 to FIG. 6 described later.

As shown in FIG. 3, in a case where sheet S has a rectangular planar shape, skew correction of sheet S can be normally performed by a typical registration operation. Here, the typical registration operation is performed by registration roller pair 53a rotating as described below under control of control unit 100. In other words, registration roller pair 53a stops rotation (or rotates in a backward direction) until the front end side (hereinafter simply referred to as the front end) of sheet S in the conveyance direction comes into contact. When the front end of sheet S comes into contact with registration roller pair 53a, rotation is started in a forward feed direction (i.e., the conveyance direction to the secondary transfer nip).

More specifically, sheet S is conveyed by loop rollers 53b at its upstream side. When the front end of sheet S comes into contact with registration roller pair 53a (in the rotation stop state or the like), a loop (sheet warp) is formed by the rotations of loop rollers 53b. At this time, the entire front end side of sheet S comes into uniform contact with the nip of registration roller pair 53a, thereby correcting the obliqueness (skew) of sheet S. Subsequently, when registration roller pair 53a starts forward feed rotation, sheet S is conveyed toward the secondary transfer nip in a state where skew is corrected.

In a typical registration operation, according to switching of the rotations of registration roller pair 53a, the obliqueness (skew) of sheet S is corrected by registration roller pair 53a, and sheet S is conveyed toward the secondary transfer nip.

On the other hand, for example, in a case where sheet S having a special planar shape as shown in FIG. 4 is used, the skew correction of sheet S cannot be normally performed by the typical registration operation described above because the angles between the front end side of sheet S in the conveyance direction and the sides at the side edges are not right (90°). In other words, a typical registration operation performed for such sheet S causes obliqueness (skew) when sheet S comes into contact with registration roller pair 53a. Consequently, during the obliqueness correction described above, the state of obliqueness (skew) of sheet S sometimes becomes worse (so called inverted correction). In such a case, there is a possibility that only the displacement operation of registration roller pair 53a after the registration operation (i.e., control of registration displacement) cannot completely correct the obliqueness of sheet S. Accordingly, the accuracy of the position of the image to be transferred at the secondary transfer nip cannot be secured (i.e., incapable of image securing).

According to image forming apparatus 1 that performs double-sided printing while switch-back-conveying sheet S as in this embodiment, in a case of double-sided printing on sheet S, during printing of the first side and the second side, the side edges of sheet S are not changed but the front end of sheet S to be in contact with registration roller pair 53a is oriented on the inverted side. Therefore, in a case where sheet S having a planar shape other than rectangular shapes is conveyed with the attitude as shown FIG. 4, the typical registration operation cannot normally achieve skew correction of sheet S even in each case of printing the first side and the second side.

Generally, to correct completely the obliqueness of sheet S by the operation of obliqueness correction by registration roller pair 53a and the like, the front end side of sheet S is required to have the completely right angle (correctly 90°) from the sides at the side edges of sheet S. On the other hand, there is sheet S that does not have the complete right angle as described above owing to the difference of the machine (cutting machine) and the production tolerance at the time of manufacturing sheets S even though sheet S is a regularly used sheet. Furthermore, also in view of the production technique, the angles between the front end side and sides at the side edges of sheet S cannot be easily configured to be the right angle. Regularly used sheets often have such angles of 89° or 91° (deviation by about 1°).

Therefore, image forming apparatus 1 of this embodiment has a configuration that can selectively execute an operation of not bringing the front end of sheet S into contact with registration roller pair 53a (registration-less operation), as the operation during conveyance of sheet S by registration roller pair 53a. In other words, control unit 100 controls the operation of registration roller pair 53a so as to execute any of the typical registration operation of bringing the front end of sheet S into contact with registration roller pair 53a (first operation) and the registration-less operation of not bringing the front end of sheet S into contact with registration roller pair 53a (second operation).

In this embodiment, the typical registration operation (first operation) is the same as the conventional registration operation described above. On the other hand, the registration-less operation (second operation) is an operation of rotating registration roller pair 53a in the conveyance direction (forward feed direction) before the front end of sheet S reaches (comes into contact with) registration roller pair 53a. In other words, when the registration-less operation is executed, control unit 100 outputs a control signal to a motor that rotatably drives registration roller pair 53a so as to rotate registration roller pair 53a in the conveyance direction before the front end of sheet S comes into contact with registration roller pair 53a.

In this example, in view of improvement in productivity, during execution of the registration-less operation, control is performed so that the rotation speeds of registration roller pair 53a can be substantially identical to the rotation speeds of loop rollers 53b. Therefore, during execution of the second operation, no loop is formed between loop rollers 53b and registration roller pair 53a. On the other hand, the rotation speeds of registration roller pair 53a at the start of execution of the registration-less operation can be adjusted to any speed through a user setting screen or the like, not shown.

During execution of such a registration-less operation, no skew correction is performed for sheet S by registration roller pair 53a. Consequently, a situation as described above where the obliqueness (skew state) of sheet S becomes worse can be prevented. However, such second operation cannot correct the obliqueness (skew) of sheet S. Accordingly, in this embodiment, after execution of the second operation, registration roller pair 53a is displaced, thereby performing obliqueness (skew) correction together with the positional deviation correction of this sheet S.

In this embodiment, the displacement operation of registration roller pair 53a can also be performed even after execution of the typical registration operation (first operation). In other words, after execution of the typical registration operation or the registration-less operation, control unit 100 controls displacement of registration roller pair 53a so as to displace sheet S in the width direction of this sheet.

In this embodiment, to image-secure sheets S having various different shapes (see FIG. 4 etc.), control unit 100 obtains sheet shape information that represents the shape of sheet S, and controls the displacement of registration roller pair 53a so as to achieve the correct position of the toner image to be transferred by the secondary transfer nip, according to such sheet shape information. Here, the sheet shape information is information that defines the external shape, i.e., the two-dimensional planar shape, of sheet S.

In one example, prior to execution of a print job, such sheet shape information is registered (stored in a memory or the like) through a user setting screen, such as on operation display unit 20 or an external apparatus (PC or the like). Control unit 100 then performs a process of determining whether to execute the typical registration operation or the registration-less operation when executing a print job, based on the preliminarily registered sheet shape information. Another method of registering the sheet shape information, and the like will be described later.

FIG. 4 illustrates a case where after execution of the second operation, registration roller pair 53a is displaced multiple times (seven times), for sheet S having a planar pentangular shape without right corners but with two acute angles and three obtuse angles instead (see arrows indicating downward). In FIG. 4, two parallel lines are added as broken lines. The lower broken line represents the reference position of a side edge of the sheet, the position being used for the typical registration displacement control. The upper broken line represents the print start position of the toner image in the sheet width direction by the secondary transfer nip. In this diagram, the broken line along the side edge of sheet S indicates the actually required amount of displacement (displacement target position) in consideration of a margin of this sheet S. The details thereof will be described later.

Here, sheet S with an imaginary line connecting two corners with acute angles identical to each other and a side connecting two corners with obtuse angles identical to each other being substantially in parallel shown in FIG. 4 is conveyed toward registration roller pair 53a with an attitude of two corners with acute angles and two corners with obtuse angles in parallel. The two corners having the acute angle are connected to a pair of inclined sides that form the largest obtuse angle and extend in a direction of denting the sheet (reducing the sheet area).

A case of printing an image on sheet S having such a special external shape has the following problem. That is, the typical registration displacement control assumes that the sheet has sides at the side edges that are straight lines. Accordingly, the displacement target position is constant (fixed) in the width direction as indicated by the lower broken line (straight line) in FIG. 4.

On the other hand, in the example shown in FIG. 4, the side edge of sheet S is not a straight line but is inclined instead. Accordingly, if registration roller pair 53a is displaced so as to align the position of the side edge of sheet S with the normal target position (the lower broken line in FIG. 4), the center part of sheet S in the conveyance direction is required to be largely moved in the width direction (to the left). Normally, the amount of displacement of registration roller pair 53a has a limit (upper limit value). In such a case, there is a possibility that the amount reaches the upper limit value of displacement of registration roller pair 53a. In this case, problems can occur that due to insufficient displacement, a rapid displacement operation, or the like, the toner image to be transferred by the secondary transfer nip is deformed, or the margin on the right side of the center part of sheet S in the conveyance direction cannot be secured (the toner image on the right side becomes out of sheet S).

Therefore, in this embodiment, control unit 100 preliminarily obtains the sheet shape information before printing sheet S, and controls displacement of registration roller pair 53a so as to align the side edge of sheet S with the target position in conformity with the side edge shape of sheet S defined in the sheet shape information. In other words, control unit 100 corrects the target position or target line of displacement indicated by the straight line in FIG. 4 to be the position or line (the chevron line in this example) in conformity with the shape of the side edge of this sheet S, according to the shape of the side edge of sheet S defined in the sheet shape information, and controls registration displacement according to the corrected position or line.

More specifically, control unit 100 controls displacement of registration roller pair 53a so as to set the target position of displacement at a plurality of points in the conveyance direction of sheet S and to align the side edge of sheet S with each of the set target positions.

As described above, control unit 100 basically controls the displacement of registration roller pair 53a so as to align the side edge of sheet S conveyed by registration roller pair 53a with the target position in conformity with the side edge shape of sheet S. Such control can align the side edge of sheet S having any of various side edge shapes with a writing start position of the toner image to be transferred by the secondary transfer nip in the width direction.

On the other hand, according to certain alignment between registration roller pair 53a and the secondary transfer nip or the fixing nip, or the like, there is a possibility that sheet S is bent at the middle thereof even in a case of performing the control described above. In particular, when sheet S is bent after passing through registration roller pair 53a, the position of the side edge of sheet S having reached the secondary transfer nip sometimes deviates.

To address such positional deviation, control unit 100 displaces registration roller pair 53a so as to align the position of the toner image to be transferred by the secondary transfer nip in the width direction with the position of the image formation area set on sheet S in a print job in the width direction (i.e., the target position on the sheet in consideration of the sheet shape information). For example, in consideration of the obliqueness of sheet S having passed through registration roller pair 53a, registration roller pair 53a is displaced so as to cause the side edge of sheet S on the rear edge side of sheet S to intentionally deviate from the target position (see the chevron broken line in FIG. 4), for example. Such control can more appropriately correct the obliqueness or positional deviation of the sheet, and prevent the positional deviation of the image from occurring.

According to description in another view, in displacement control after execution of the first operation or the second operation, control unit 100 displaces registration roller pair 53a so as to appropriately correct the target position of the side edge of sheet S (i.e., appropriately shifts the position of the chevron broken line in FIG. 4) and bring the side edge of the sheet to the corrected target position.

To perform such displacement control of registration roller pair 53a, for example, an image reading apparatus (scanner or the like), not shown, is provided at the subsequent stage of image forming apparatus 1, and preliminary printing is performed on sheet S by image forming apparatus 1. The position of the image on preliminary printed sheet S is read by the image reading apparatus, and the degree of positional deviation is detected. The result of such detection is reflected in (fed back to) the correction value of the target position of the side edge of sheet S during actual printing.

As described above, the various processes for displacement of registration roller pair 53a are performed, which can improve the accuracy of the position of the toner image to be transferred to sheet S by the secondary transfer nip, the position being in the sheet width direction.

After execution of the typical registration operation or the registration-less operation, control unit 100 performs control of adjusting the rotation speed (i.e., the conveyance speed of sheet S) of registration roller pair 53a so as to align the front end of sheet S with the position in the sheet conveyance direction at which the image (toner image) is to be transferred by the secondary transfer nip (transfer section). This control is referred to as “front end timing matching”, which accelerates and decelerates the conveyance speed of sheet S to match finally with the conveyance speed of the secondary transfer nip according to a publicly known method, and is performed in parallel with the displacement operation of registration roller pair 53a.

In this embodiment, control of the front end timing matching after execution of the registration-less operation is started at a predetermined timing after the front end of sheet S comes into contact with registration roller pair 53a. For example, as shown in FIG. 4, in a case where sheet S has a planar shape with the front end side that is an inclined side non-parallel with the axes of registration roller pair 53a, control of the front end timing matching is started at a timing when this inclined side of sheet S passes out of the nip of registration roller pair 53a (a timing when the entire width of sheet S is sandwiched by the registration nip). In another example, control of the front end timing matching after execution of the second operation is started at a timing when a part of the sheet is detected by line sensor 54.

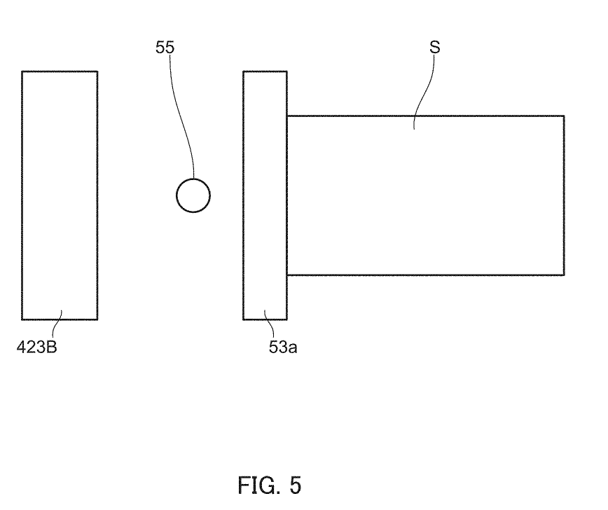

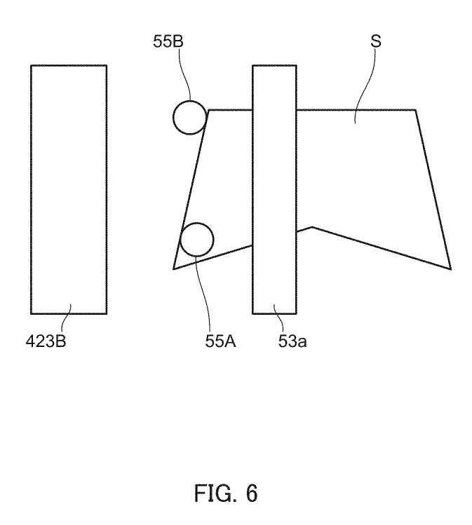

In still another example, beside line sensor 54, a sensor (front end sensing sensor 55) for sensing the front end of sheet S is disposed as shown in FIG. 5 and FIG. 6, and control of the front end timing matching after execution of the registration-less operation is started at a timing when the front end of sheet S is sensed by such a sensor. Here, FIG. 5 illustrates a case where one front end sensing sensor 55 is provided. FIG. 6 illustrates a case where multiple front end sensing sensors 55 (two sensors 55A and 55B) are provided in the direction of the axes of registration roller pair 53a and the secondary transfer nip. As shown in FIG. 6, in the case where multiple front end sensing sensors 55 are provided, the inclination of the inclined side on the front end of sheet S can be estimated. Consequently, the front end timing, in turn, the writing start position of the image on the front end side of sheet S can be more accurately controlled. Such front end sensing sensors 55, 55A and 55B are not specifically limited only if the sensors can sense the front end of the sheet. For example, the sensors may be any of optical or physical sensors.

In this embodiment, the displacement operation of registration roller pair 53a after execution of the registration-less operation has both aspects of the skew correction of sheet S and of the positional deviation correction of the side edge of sheet S (hereinafter simply referred to as positional deviation correction). In this embodiment, an operation of sequentially moving sheet S in the width direction (the direction orthogonal to the conveyance direction) is performed so as to align always the side edge of sheet S with the target position by displacing registration roller pair 53a multiple times or continuously after execution of the registration-less operation (second operation), for example. Such a displacement operation, that is, the displacement control of registration roller pair 53a by control unit 100 is continued (appropriately executed) even after sheet S reaches the secondary transfer nip. Such a displacement operation of registration roller pair 53a can correct the obliqueness (skew) and positional deviation of sheet S before transfer of the toner image by the secondary transfer nip is started, without depending on the shape of the front end of sheet S. As a result, improvement in the positional accuracies of the images transferred onto the various types of sheets can be achieved.

It may be configured such that it can be automatically or freely selected whether to execute the typical registration operation (first operation) or the registration-less operation (second operation) as the operation during conveyance of the sheet by registration roller pair 53a.

In other words, in the case where sheet S has an external shape with an inclined front end and side edge of sheet S as described above (see FIG. 7B), the angles at the corners of sheet S each deviate largely from 90°. There is a possibility that when the registration operation (first operation) analogous to the conventional operation is performed, subsequent control of registration displacement cannot address the deviation (image securing cannot be achieved).

On the other hand, with a certain shape of sheet S, typically, in a case where sheet S is a regularly used sheet and the angles of the corners are each significantly close to 90° (see FIG. 7A), it is believed that the registration operation (first operation) analogous to the conventional operation and the control of the registration displacement can sufficiently address the deviation (i.e., image securing can be achieved) in some cases.

In the aforementioned view, prior to execution of the print job, the sheet shape information, which represents the shape of sheet S, is registered, as described above. During execution of the print job, control unit 100 identifies the shape (the angles at the corners etc.) of sheet S on the front end side in the conveyance direction on the basis of the sheet shape information, and executes a process of determining whether to execute the typical registration operation (first operation) or the registration-less operation (second operation). In an example, control unit 100 determines execution of the typical registration operation in a case where the number of corners of sheet S on the front end side in the conveyance direction is two and the angles with the side edges are the right angle, while determining execution of the registration-less operation in other cases.

The sheet shape information can be set and registered by a user's manually inputting numerical values for the external shape of sheet S (the longitudinal and lateral lengths and the angles of the corners) through the user setting screen described above. Alternatively, a sheet shape table where these numerical values for the external shape of sheet S are compiled as a list or a table may be preliminarily registered, and the setting and registration are made by the user's manual selection during execution of the print job.

Alternatively, to register the sheet shape information automatically, for example, a reading apparatus that includes an optical sensor, such as a scanner, not shown, is connected at the subsequent stage of image forming apparatus 1. A sheet passing test that conveys a sheet without using displacement of registration roller pair 53a and without printing is performed. During the sheet passing test, the external shape of the sheet used by image forming apparatus 1 is preliminarily detected by the reading apparatus. Here, the external shape of the sheet detected by the reading apparatus is transmitted as the sheet shape information from the reading apparatus to image forming apparatus 1. Control unit 100 stores the received sheet shape information in storage unit 72 or RAM 103. Such a process can correctly detect the shape of the sheet (the length of each side, the angle of each corner, the curvature of a curved side if any, etc.), and set the shape as the sheet shape information.

Alternatively, during the sheet passing test, the shape of the side edge of the sheet detected by line sensor 54 may be registered as the sheet shape information. In this case, the sheet shape information can be obtained without using the reading apparatus described above.

It is believed that the external shapes of sheets have shapes identical or significantly close to each other if the sheets belong to the same lot. Therefore, registration (update or the like) of the sheet shape information may be performed on a lot-by-lot basis. In a case where, for example, a sheet feeding apparatus (not shown) that supplies a long sheet or the like is connected to image forming apparatus 1, the sheet shape information can be required to be newly registered.

In the aforementioned view, when sheet feed tray units 51a to 51c are opened or closed or the sheet feeding apparatus, not shown, is connected, control unit 100 displays that the sheet shape information should be registered or updated, on operation display unit 20, to thereby urge the user to register or update the information, or executes the sheet passing test described above to obtain the sheet shape information automatically. Such a process can readily obtain the sheet shape information when the lot, sheet type or the like of the sheet to be used is changed.

Further alternatively, the aforementioned reading apparatus that detects the external shape of the sheet may be disposed in image forming apparatus 1 (upstream of registration roller pair 53a), the sheet shape information may be obtained in real-time during execution of the print job.

Control unit 100 can obtain the sheet shape information by any of various methods as described above, and execute any one of the registration-less operation and the typical registration operation on the basis of the obtained sheet shape information. Control unit 100 controls registration roller pair 53a so as to align the side edge of sheet S with the target position in conformity with the side edge shape of sheet S, on the basis of the obtained sheet shape information.

Image forming apparatus 1 of this embodiment that performs the operation control of registration roller pair 53a as described above can freely transfer toner images on sheets S having various different shapes.

It may be configured to allow the user to set whether to execute the typical registration operation or the registration-less operation, through the user setting screen described above. For example, there can be a case where it is apparent that the registration operation (first operation) analogous to the conventional operation and the control of registration displacement cannot address the problem (incapable of image securing) seemingly from the external shape of sheet S, or an opposite case as described in FIG. 7A. Therefore, it may be preset so that the user can select whether to execute the first operation or the second operation.

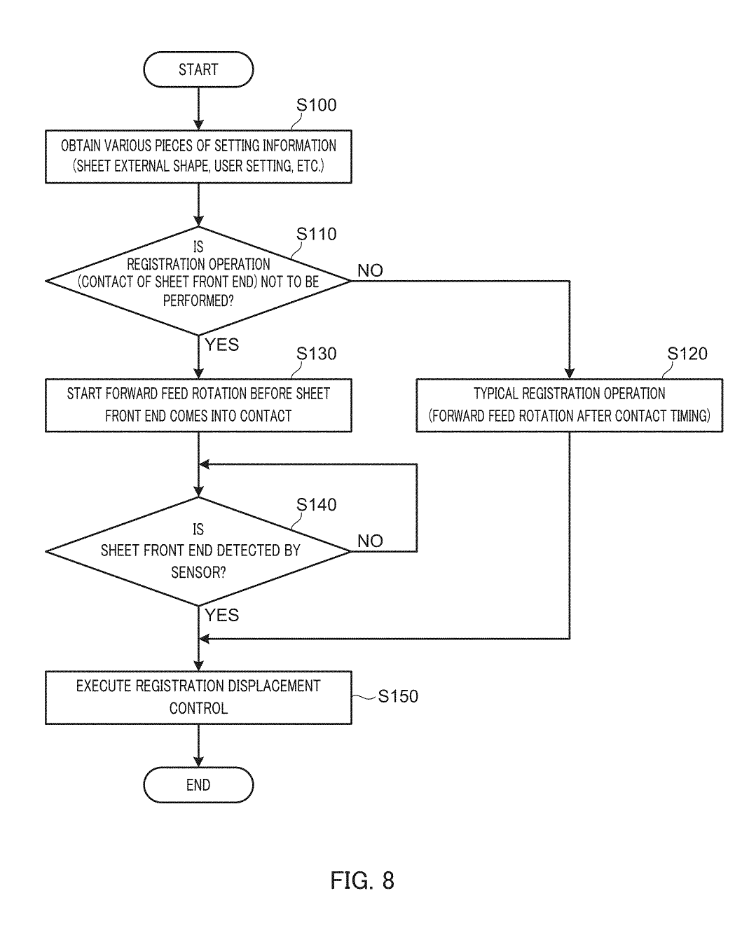

An example of a process executed by control unit 100 for the operation of registration roller pair 53a in image forming apparatus 1, in turn, conveyance control of sheet S, will be described with reference to a flowchart of FIG. 8. This example assumes a case where front end sensing sensors 55A and 55B described above with reference to FIG. 6 are provided and sheet S having the special shape described with reference to FIG. 4 and the like is used.

During execution of the print job, control unit 100 obtains various pieces of setting information in the print job (step S100). Here, control unit 100 obtains setting information that includes user settings for, for example, information representing the type of sheet S including the sheet shape information described above (e.g., the number of sides, the length of each side, the angle of each corner, and the basis weight of sheet S, etc.), the attitude of sheet S, selection of the operation of registration roller pair 53a, presence or absence of double-sided printing, and the like.

In step S110, control unit 100 refers to the obtained setting information, and determines whether not to perform the registration operation (contact of the front end of the sheet) described above, that is, whether to perform the second operation or the first operation. In this example, control unit 100 determines to execute the second operation (registration-less operation) (YES in step S110) on the basis of the sheet shape information, and the processing transitions to step S130.

In step S130, control unit 100 controls the drive source of registration roller pair 53a so as to start the forward feed rotation before the front end of sheet S reaches (comes into contact with) registration roller pair 53a (execution of the second operation). According to this control, registration roller pair 53a conveys sheet S as it is toward the secondary transfer nip without performing the operation of bringing the front end of sheet S into contact (temporary stop) (see FIG. 6). Therefore, if sheet S has an obliqueness (skew), the obliqueness is not corrected at this time, but can reduce the conveyance time to the secondary transfer nip instead.

At this time, as described above, control unit 100 sets the target position (the chevron target line indicated by the broken line in FIG. 4) in conformity with the side edge shape of sheet S defined in the sheet shape information, and the number of times of displacing registration roller pair 53a.

In step S140 subsequent to step S130, control unit 100 monitors the signals sensed by front end sensing sensors 55A and 55B, and determines whether sheet S is detected by sensors 55A and 55B or not. During detection by control unit 100 that sheet S is not detected by sensors 55A and 55B (NO in step S140), this unit assumes that the front end of sheet S does not reach the positions of sensors 55A and 55B and repeats the determination in step S140. On the other hand, if control unit 100 determines that sheet S is sensed by sensors 55A and 55B (YES in step S140), the processing transitions to step S150.

In step S150, control unit 100 controls the rotation and displacement of registration roller pair 53a so as to perform the operation of the sheet front end timing matching described above, and the operation of the registration displacement (sheet side edge alignment). As for the operation of the registration displacement, in this example, control unit 100 displaces registration roller pair 53a in the width direction seven times so as to align the position of the side edge of sheet S sensed by line sensor 54 with the target position in conformity with the position of sheet S in the conveyance direction (the chevron target line indicated by the broken line in FIG. 4).

After execution of the registration displacement control in step S150, control unit 100 ends the above-described series of processing. The registration displacement control in step S150 can be continued even after sheet S reaches the secondary transfer nip.

During execution of the double-sided print job, control unit 100 returns to step S110 after step S150, and performs conveyance control for the second side of sheet S. In this example, the side of sheet S on the front end side is an inclined side, and the front end of the second side after the switch-back conveyance is also an inclined side. Furthermore, in this example, the left side edge in the conveyance direction is a non-straight line, that is, the chevron inclined side. Likewise, the left side edge of the second side after switch-back conveyance is also a chevron inclined side. Therefore, control unit 100 determines to execute the registration-less operation also for the second side (YES in step S110), the processing transitions to step S130, and this unit executes the control analogous to that for the first side.

In another print example, in a case where the angle of each corner of sheet S is significantly close to 90° as described in FIG. 7A and the like, control unit 100 determines to execute the typical registration operation (first operation) for both the first side and the second side of sheet S (NO in step S110), the processing transitions to step S120 and then to step S150 described above. According to the control of the first operation in step S120, registration roller pair 53a continues the rotation stop state or the reverse feed rotation state until the front end of sheet S comes into contact, and then starts the forward feed rotation when the front end of sheet S comes into contact with registration roller pair 53a. According to the first operation, the obliqueness of sheet S is corrected by registration roller pair 53a, and sheet S is conveyed to the secondary transfer nip with the attitude whose skew state is corrected.

Image forming apparatus 1, which performs the control described above, can achieve improvement in positional accuracies of images to be transferred onto the sheets having various shapes.

In the embodiment described above, description has been made with the example of the case where the registration-less operation is performed for pentangular sheet S having three obtuse angles, as the special sheet. On the other hand, the registration-less operation in this embodiment is applicable to sheets having various external shapes as described above, and further applicable to completely rectangular sheet S in an analogous manner.

Generally, image forming apparatus 1 in this embodiment, which performs the conveyance control as described above, can secure the accuracy of the position of an image to be formed (in turn, image securing) regardless of the shape of the front end and the side end, the inclined angle, and the like of sheet S.

The above embodiment has been described in terms of a case where flat sheets are used as the sheets. However, the above embodiment is applicable also to rolled sheets in an analogous manner.

The above embodiments has been described in terms of an example of an image forming apparatus including a transfer section that secondarily transfers an image to be printed, onto sheet S using intermediate transfer belt 421. However, the above embodiments are applicable also to image forming apparatuses of a transfer type in which an image to be printed is primarily transferred onto sheet S (for example, a monochrome printer, an inkjet printer, etc.).

Although embodiments of the present invention have been described and illustrated in detail, the disclosed embodiments are made for purpose of illustration and example only and not limitation. The scope of the present invention should be interpreted by terms of the appended claims.

What is claimed is:

1. An image forming apparatus, comprising:
a transferrer that transfers an image onto a sheet;
a registration roller provided upstream of the transferrer in a sheet conveyance direction; and
a hardware processor that controls an operation of the registration roller;
wherein the hardware processor executes a registration-less operation of not bringing a front end of the sheet in the conveyance direction into contact with the registration roller, and subsequently controls displacement of the registration roller so that a position of an image to be transferred onto the sheet by the transferrer can be corrected according to sheet shape information representing a shape of the sheet.

2. The image forming apparatus according to claim 1,
wherein during the registration-less operation, the hardware processor performs control of rotating the registration roller in the conveyance direction before the front end of the sheet comes into contact with the registration roller.

3. The image forming apparatus according to claim 1,
wherein the hardware processor controls displacement of the registration roller so as to align side edges of the sheet with a target position in conformity with a side edge shape of the sheet defined in the sheet shape information.

4. The image forming apparatus according to claim 3,
wherein the hardware processor controls displacement of the registration roller so as to set the target position at a plurality of points in the conveyance direction of the sheet and to align a side edge of the sheet with each of the set target positions.

5. The image forming apparatus according to claim 1,
wherein after execution of the registration-less operation, the hardware processor performs control of adjusting a rotation speed of the registration roller so as to achieve alignment with a position in the sheet conveyance direction where the image is transferred by the transferrer.

6. The image forming apparatus according to claim 1,
wherein the image forming apparatus can select whether to perform the registration-less operation or a registration operation of bringing the front end of the sheet into contact with the registration roller to perform skew correction.

7. The image forming apparatus according to claim 6,
wherein the hardware processor executes one of the registration-less operation and the registration operation, based on the sheet shape information.

8. The image forming apparatus according to claim 1,
wherein the hardware processor controls displacement of the registration roller so as to align a position of an image to be transferred by the transferrer in a width direction with a position of an image formation area in the width direction, based on the sheet shape information, the image formation area being set on the sheet.

9. The image forming apparatus according to claim 1,
wherein the sheet shape information can be set in advance.

10. The image forming apparatus according to claim 9,
wherein the hardware processor executes the registration-less operation or the registration operation, based on the sheet shape information set through an operation and input section.

11. The image forming apparatus according to claim 9,
wherein the hardware processor executes the registration-less operation or the registration operation, based on the sheet shape information obtained by a sensor reading an external shape of the sheet.

12. A conveyance control method of an image forming apparatus comprising a transferrer that transfers an image onto a sheet, and a registration roller provided upstream of the transferrer in a sheet conveyance direction,
the method executing a registration-less operation of not bringing a front end of the sheet in the conveyance direction into contact with the registration roller, and subsequently displacing the registration roller so that a position of an image to be transferred onto the sheet by the transferrer can be correct according to sheet shape information representing a shape of the sheet.
